(19) United States
(12) Patent Application Publication
(10) Pub. No.: US 2021/0201304 A1
(43) Pub. Date: Jul. 1, 2021

(54) System and Method for Performing Transactions with an Electronic Ledger

(71) Applicant: Google LLC, Mountain View, CA (US)

(72) Inventors: Govind Kaushal, Alameda, CA (US); Prakash Prem Hariramani, Burlingame, CA (US); Ceasar Sengupta, Singapore (SG)

(21) Appl. No.: 17/134,846

(22) Filed: Dec. 28, 2020

Related U.S. Application Data
(60) Provisional application No. 62/954,006, filed on Dec. 27, 2019.

(51) Int. Cl. G06Q 20/38; G06Q 20/02; G06Q 20/40; G06Q 20/22; G06N 20/00

(52) U.S. Cl. CPC G06Q 20/389; G06Q 20/027; G06Q 20/403; G06N 20/00; G06Q 20/4016; G06Q 20/407; G06Q 20/223

(57) ABSTRACT

One example aspect of the present disclosure is directed to a computing system that includes at least one processor and at least one tangible, non-transitory computer-readable medium that stores instructions that, when executed by the at least one processor, cause the at least one processor to perform operations. The operations can include receiving, at a user computing device, an input that requests conducting a financial transaction with respect to a financial institution account that is provided by a financial institution; and adjusting, at a platform server system that is controlled by an entity that is different and distinct from the financial institution, an electronic ledger to conduct the financial transaction; and transmitting, from the platform server system to the financial institution, data describing the electronic ledger.

### CROSS-REFERENCE TO RELATED APPLICATION

The present application claims filing benefit of U.S. Provisional Patent Application Ser. No. 62/954,006 having a filing date of Dec. 27, 2019, which is incorporated herein by reference in its entirety.

### FIELD

The present disclosure relates generally to payment and identification systems. More particularly, the present disclosure relates to systems and methods for performing transactions with an electronic ledger.

### BACKGROUND

Electronic financial transactions are prone to fraud. Investigating fraud, such as requests to refund fraudulent charges, consumes substantial resources. Information about financial transactions is generally collected and stored in a variety of disparate locations (e.g., databases, servers, etc.) such that data must be collected from multiple locations and reconciled to investigate a charge that is reported as fraudulent. Collecting and reconciling such information increases the time and costs involved with investigating fraud.

### SUMMARY

Aspects and advantages of embodiments of the present disclosure will be set forth in part in the following description, or can be learned from the description, or can be learned through practice of the embodiments.

One example aspect of the present disclosure is directed to a computing system that includes at least one processor and at least one tangible, non-transitory computer-readable medium that stores instructions that, when executed by the at least one processor, cause the at least one processor to perform operations. The operations can include receiving, at a user computing device of a computing system, an input that requests conducting a financial transaction with respect to a financial account that is provided by a financial institution; adjusting, at a platform server system that is controlled by an entity that is different and distinct from the financial institution, an electronic ledger to conduct the financial transaction; and transmitting, from the platform server system to the financial institution, data describing the electronic ledger.

Another example aspect of the present disclosure is directed to a computer-implemented method. The method can include receiving, at a user computing device, an input that requests conducting a financial transaction with respect to a financial account that is provided by a financial institution; adjusting, at a platform server system that is controlled by an entity that is different and distinct from the financial institution, an electronic ledger to conduct the financial transaction; and transmitting, from the platform server system to the financial institution, data describing the electronic ledger.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing system according to example embodiments of the present disclosure.

FIG. 1C depicts a block diagram of an example computing system according to example embodiments of the present disclosure.

FIG. 2A depicts a simplified flow chart of a method for performing a merchant transaction according to aspects of the present disclosure according to aspects of the present disclosure.

FIG. 2B illustrates a flowchart of a settlement procedure according to aspects of the present disclosure.

FIG. 2C illustrates a flowchart of a settlement procedure according to aspects of the present disclosure.

FIG. 3 depicts a simplified flow chart of a method for performing a peer-to-peer transaction according to aspects of the present disclosure.

FIG. 4A illustrates is a simplified flowchart of a method for setting up a new platform account and setting up a bank account for a user according to aspects of the present disclosure.

FIG. 4B illustrates a simplified flowchart of a method for setting up the new bank account and/or platform account for the user according to aspects of the present disclosure.

FIG. 5A illustrates an example series of views of a user interface depicting a method for creating a new platform account and creating a new bank account for a user according to aspects of the present disclosure.

FIG. 5B illustrates additional views corresponding with additional steps for creating the platform account and bank account.

FIG. 6A illustrates is a simplified flowchart of a method for creating a new platform account in associated with an existing bank account of the user.

FIG. 6B illustrates a simplified flowchart of a method for creating a new platform account and/or linking the platform account to the existing bank account of the user.

FIG. 7A illustrates an example series of views of a user interface depicting a method for creating a new platform account for the user and linking the new platform account to an existing bank account of the user according to aspects of the present disclosure.

FIG. 7B illustrates additional views corresponding with additional steps for creating a new platform account for the user and linking the new platform account to an existing bank account of the user according to aspects of the present disclosure.

FIG. 8 illustrates a first view and second view of a user interface configured to allow a primary user to set privileges or constraints with respect to connected accounts according to aspects of the present disclosure.

FIG. 9A depicts a simplified flow chart diagram of an example method for depositing or withdrawing physical currency from the user's platform account that can be initiated at an ATM or bank according to aspects of the present disclosure.

FIG. 9B depicts a simplified flow chart diagram of an example method for depositing or withdrawing physical currency from the user's platform account that can be initiated with the user's computing device and/or platform application according to aspects of the present disclosure.

FIG. 10 depicts a flow chart diagram of an example method for performing transactions with an electronic ledger according to aspects of the present disclosure.

Reference numerals that are repeated across plural figures are intended to identify the same features in various implementations.

### DETAILED DESCRIPTION

### Overview

Generally, the present disclosure is directed to systems and methods for performing transactions and/or facilitating transactions with an electronic ledger. For example, a transaction service platform or layer can be provided through which financial transactions can be completed with user's financial account (e.g., bank account, credit card, and the like). Financial transactions can be completed between users and merchants and/or between users and other users. This platform can provide increased security when creating new bank account and/or platform accounts. The process of verifying customers is generally referred to as “Know Your Customer” (KYC). The systems and methods described herein can greatly improve the KYC process. Additionally, data that is useful for detecting or investing fraud can be more easily collected by the transaction service platform (e.g., in the electronic ledger(s)). In appropriate situations, this data can be provided to banks, credit card companies, and/or other investigators, for example in response to a transaction being flagged or reported as suspect or potentially fraudulent. Lastly, a variety of controls or constraints can be enforced with respect to transactions performed via the platform. Such control or constraints can be useful for tracking individual spending, tracking family spending, and facilitating bank accounts for minors (e.g., teenagers and/or children).

The transaction service platform described herein can maintain an electronic ledger and communicate with various financial institutions (e.g., banks) to facilitate transactions. For example, the transaction service platform or layer can provide the users and/or merchants with platform accounts. The platform accounts can be linked or tied to the users' and/or merchants' respective bank accounts at financial institutions. When a transaction is requested, the electronic ledger can be updated to reflect changes in balances in the platform accounts. For instance, the electronic ledger can be updated throughout the day to reflect transactions as they occur. The electronic ledger and/or data describing the electronic ledger can be sent to the financial institutions, for example, in a bulk transmission at the end of each day. The financial institutions can update the respective accounts (e.g., bank accounts, credit card accounts, etc.) at the financial institutions based on the electronic ledger and/or data describing the electronic ledger.

More specifically, in some implementations, a user computing device can be configured to receive an input that requests conducting a financial transaction with respect to a financial account that is provided by a financial institution. As one example, a user can request that funds be sent to another user in a peer-to-peer transaction. As another example, a user can request that funds be sent to a merchant to pay for a good or service provided by the merchant.

Data that describes the electronic ledger can be transmitted from the platform server system to the financial institution server system, for example in a bulk transmission at the end of each day. For example, a ledger entry that describes the financial transaction and/or a platform account can be transmitted to the financial institution server system.

The financial platform and/or layer can verify that the bank account has sufficient funds to complete the transaction. Before adjusting the electronic ledger, a fund balance described by the financial account can be compared to a fund amount described by the financial transaction. For instance, the computing system can verify that the fund amount of the financial transaction is greater than or equal to the fund amount described by the financial transaction.

In some implementations the financial institution(s) can review and authorize some or all transactions. In such implementations, the financial institution server system can provide an authorization decision in response to receiving an authorization request from the financial platform server system. For example, this request can be sent before updating the electronic ledger and/or facilitating the transaction with respect to the platform account of the user. As another example, the financial platform server can provide an authorization decision in response to receiving the electronic ledger. Thus, the financial platform can facilitate the transaction with respect to the platform account layer.

In some implementations, the platform provider can analyze the requested transaction and provide the financial institution with data describing results of the analysis to help facilitate the financial institution's determination of whether to authorize the requested transaction. For example, the platform provider can facilitate generation of a confidence score for the requested transaction request. The confidence score can describe relative risk of the requested transaction request, for example risk that the requested transaction request is fraudulent. The confidence score can be transmitted to the financial institution server computing system to assist the financial institution server computing system when determining whether to authorize the transaction.

In some implementations, one or more machine-learned models can be used to generate the confidence score. The transaction analysis model(s) can be stored and/or executed on the platform server system and/or locally on the user computing device. The transaction analysis model(s) can be configured to receive transaction data describing the requested financial transaction (e.g., transaction amount, location, time, etc.) and/or user data describing the user (user location, user transaction history). In response to receipt of one or more of the transaction data or the user data, the transaction analysis model(s) can output the confidence score with respect to the financial transaction. Data describing the requested financial transaction (e.g., including the confidence score) can be transmitted to the financial institution server computing system(s) (e.g., from the platform server computing system(s) and/or user computing device) to assist the financial institution in determining whether to authorize the transaction.

Additionally, in some implementations, a rules-based approach can be applied to generate the confidence score. As an example, the rules-based approach can be based on a comparison of the user's current location with location information associated with the requested transaction. As another example, the rules-based approach can apply rules about the transaction amount (e.g., flagging transactions over a certain amount as high risk), user transaction history (e.g., transactions that deviate from normal transactions of the user can be flagged as high risk) and so forth. Further, in some embodiments, a combination of the rules-based approach and using one more machine-learned models can be used.

In alternative implementations, the financial platform can authorize the transaction(s) on behalf of the financial institution. The financial institution server can automatically update the account balance of the financial account in response to receiving the electronic ledger. For example, the financial platform provider and financial institution can delegate authorization authority to the financial platform provider (e.g., by agreement). The financial institution can set a variety of controls or privilege settings for transactions to limit this authority. For example, the controls or privileges can be set with respect to spending and/or withdrawal limits (e.g., per transaction, day, week, month, etc.), or other suitable limits. These limits can vary for different categories of users and merchants and/or can vary for individual users and/or merchants. Further, the limits can vary depending on context (e.g., based on recent spending activity, based on the location of recent spending activity, etc.). Thus, in some embodiments the financial platform server can authorize financial transactions with little or no oversight or review from the financial institution.

In such alternative implementations, the electronic ledger can be adjusted (e.g., instantly or near instantly) to conduct or facilitate the financial transaction. The electronic ledger can be controlled (e.g., operated, maintained) by an entity (e.g., the platform service provider) that is different and distinct from the financial institution. For example, the electronic ledger can be maintained at a platform server system that is separate and distinct from a financial institution server system. The financial institution can lack control and/or authority to make edit and/or access the platform server system. The financial institution can maintain separate ledgers that represent or track bank account balances (e.g., at the financial institution server system). The financial institution server system can be controlled, operated, and/or maintained by the financial institution (e.g., bank, credit card company, etc.). However, it should be understood that the financial institution server system and platform server system do not necessarily need to by physically separate and distinct. Thus, the platform service provider can control the electronic ledger(s) to facilitate the financial transaction.

Generally, the entity that authorizes the transaction also bears the financial liability and/or responsibility associated with the transaction. Thus, in embodiments described herein in which the financial institution authorizes the transaction, the financial institution generally bears the resulting liability for the authorization decision. However, at least in some embodiments in which the platform provider authorizes the transaction on behalf of the financial institution, the financial institution can nevertheless bear the liability and/or responsibility for the transaction. For instance, the financial institution and platform provider can agree to such an arrangement to facilitate faster transaction processing. The platform provider can be better equipped than the financial institution to analyze the requested transaction. For example, the platform provider can have access to more recent and/or more complete data about the transaction and/or parties involved in the transaction. The financial institution can control (e.g., as described above) one or more aspects of the decision-making process used by the platform provider, for example to minimize risk and liability associated with delegating authorization authority. Thus, in some embodiments, an entity that has not authorized the transaction can nevertheless bear the liability and/or responsibility for the transaction, which is contrary to the general convention for transaction authorization and liability.

In some implementations, a platform application can be provided for interfacing with and/or controlling the financial platform or layer. The platform application can provide updates and/or notifications with respect to the financial transaction, financial account, financial institution, an electronic ledger. For instance, data describing the financial transaction can be displayed in a display window of the platform application, such as a confirmation, notification, amount, merchant, sender, recipient, etc.

In some implementations, the platform application can provide the user with a consistent user experience when accessing multiple bank accounts respectively provided by different banks. For example, the computing system can provide data describing the financial account and data describing at least one additional financial account of the user for display by the user computing device in a display window of the platform application. The financial account can be provided by a first financial institution (e.g., a first bank) and the additional financial account(s) can be provided by a second financial institution (e.g., a second bank) that is distinct from the first financial institution.

In some implementations, the computing system (e.g., transaction service platform and/or platform application) can facilitate creation of a new platform account and/or creation of the financial account. The transaction service platform can receive, at the user computing device, an input that requests creating the financial account at the financial institution server system. The computing system can transmit, to the financial institution server system, a request for creating the financial account at the financial institution server system. The financial institution can create the financial account for the user in response to receiving the request.

The computing system (e.g., transaction service platform and/or platform application) can collect information from the user to verify the user's identity before creating the platform account and/or financial account, for example “KYC” information. The computing system can receive, at the user computing device, user information. For instance, the user information can include a photo of the user's face. The user can capture the picture of the user's face using a camera of the user computing device and/or a picture of an identification card (e.g., driver's license, passport, etc.) of the user. For instance, the user can capture a picture of the user holding his identification card next to his fact. The platform application can prompt the user to take such a picture. As additional examples, the user information can include the user's name, user's date of birth, user's address, and the like (e.g., as recognized from the picture of the identification card and/or as input by the user). The computing system (e.g., the user computing device) can transmit, to the financial institution server system, data describing the user information. The computing system can verify, at the financial institution server system, an identity of the user based on the user information.

In some implementations, the computing system (e.g., transaction service platform and/or platform application) can facilitate transactions that include interactions with physical currency. For example, the financial transaction requested by the input can include a physical currency interaction. The physical currency interaction can include depositing or withdrawing physical currency with respect to the financial account. For example, the user can initiate a cash withdrawal and/or deposit from the application platform (e.g., on a mobile computing device). The user can complete the transaction at a bank or automated teller machine (ATM).

As another example, the computing system (e.g., transaction service platform and/or platform application) can facilitate providing change for a transaction that involves physical currency. The user can pay a merchant with cash for a good or service. The computing system can provide the user with an option to receive change for the transaction via the transaction service platform and/or platform application.

Aspects of the present disclosure are directed to facilitating fraud detection and/or providing information to help investigate fraud. For example, the computing system can receive a chargeback request that identifies a suspect transaction. In response to receiving the chargeback request the computing system can transmit, from the platform server system to the financial institution server system, data that describes the electronic ledger with respect to the suspect transaction. Example data that describes the electronic ledger with respect to the suspect transaction can include a transaction day of the suspect transaction, a transaction time of the suspect transaction, a merchant involved with the suspect transaction, a location of the merchant, an identity and/or location of another user involved with the suspect transaction, or an amount of the suspect transaction.

Investigating chargeback requests can be difficult for several reasons. For example, a user can unknowingly report an authorized charge as fraudulent. The user can report a charge as fraudulent that was actually made by another authorized user of the account (e.g., a spouse or child). As another example, some users can knowingly report an authorized charge as fraudulent in an attempt to commit fraud themselves. Other variations can exist that make investigating chargeback requests difficult. The present systems and methods can make investigating such chargeback requests easier and more efficient by providing the investigator with a more complete picture of the transaction. More specifically, the data described above with respect to the electronic ledger and the suspect transaction can be communicated to the investigator. Thus, most or all of the data required to investigate can be obtained from this single source, which can eliminate or mitigate the need to receive data from multiple sources and/or reconcile data from different sources.

In some implementations, various controls and/or privilege settings can be defined and/or enforced with respect to the financial account(s). For example, the computing system (e.g., transaction service platform and/or platform application) can provide accounts for children that are monitored and/or restricted (e.g., by parents or guardians of the children). More specifically, before adjusting the electronic ledger, the computing system can compare a financial transaction requested by the input with one or more privileges settings for the user that have been set by the user or set by another user (e.g., parent). For example, the user can set spending limits, withdrawal limits, or other limits for transactions for the financial account. The computing system can determine whether the financial transaction is permitted based on the comparison of the financial transaction with the one or more privileges settings for the user.

As another example, financial institutions can set one or more controls or privileges. For example, the financial institution can set spending limits, withdrawal limits, or other limits for transactions for the financial account. The computing system (e.g., transaction service platform and/or platform application) can compare the financial transaction requested by the input with the controls set by the financial institution. The computing system can determine whether the financial transaction is permitted based on the comparison of the financial transaction with the control(s) set by a financial institution.

As discussed above, aspects of the present disclosure are directed to a layer or platform through which transactions can be facilitated with bank accounts. A platform account can be provided that is linked to a bank account. For instance, the platform account balance can be equal to the account balance of the bank account. However, it should be understood that, in some embodiments, the platform account can act as a layer through which transaction are conducted with the user's bank account. In such embodiments, the platform account balance can correspond with (e.g., be equal to) the bank account balance. In other words, as indicated above, the platform account can (1) act as an interface/layer through which the user can conduct transactions with the linked bank account and/or (2) act as a stand-alone account including separate funds than the user's bank account.

The systems and methods of the present disclosure can provide a number of technical effects and benefits. For example, the systems and method can improve security by facilitating data location in a central location (e.g., platform server device). Such data collection can improve fraud detection and/or improve efficiency of analyzing suspect charges or chargeback disputes. As another example, increased security can be provided when creating new accounts. For example, KYC data (e.g., photos of the user's face and/or identification card) can be collected at a mobile computing device. The KYC data can be transmitted to a bank to verify the user's identity before creating a new platform account and/or new bank account for the user. Lastly, a variety of controls or constraints can be enforced with respect to transactions performed via the platform. Such control or constraints can be useful for tracking individual spending, tracking family sending, and facilitating bank accounts for children.

With reference now to the Figures, example embodiments of the present disclosure will be discussed in further detail.

### Example Devices and Systems

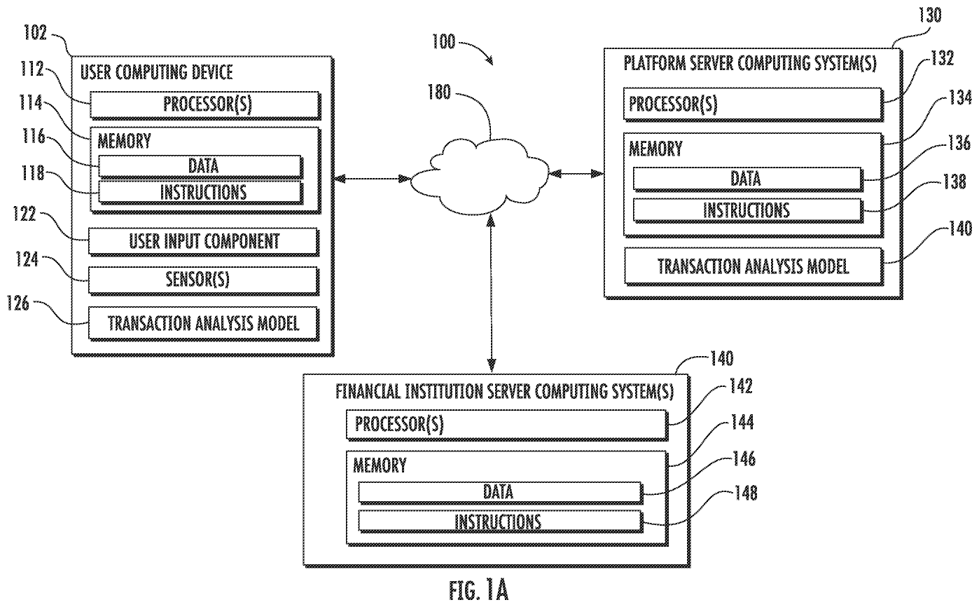

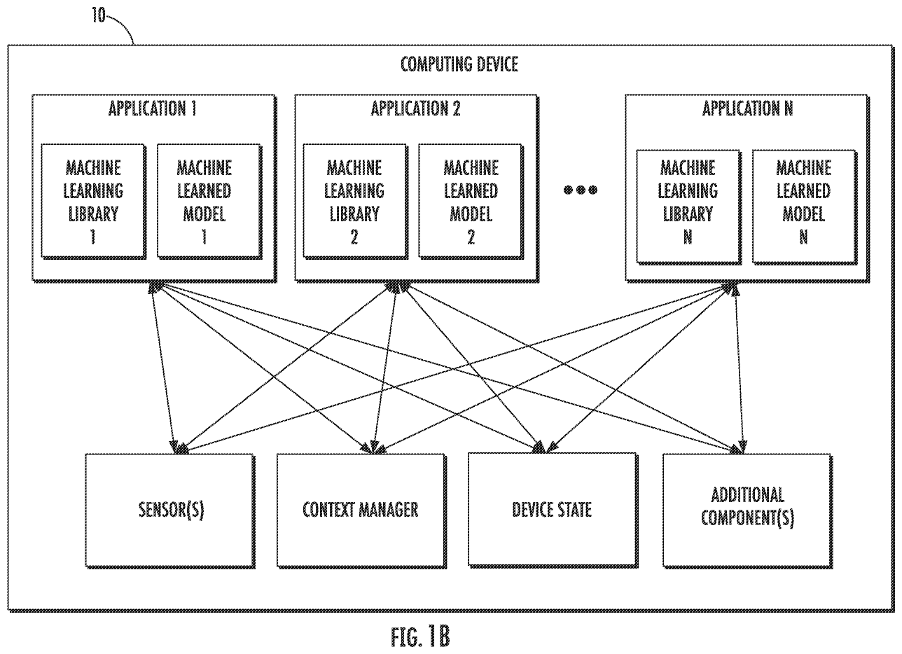

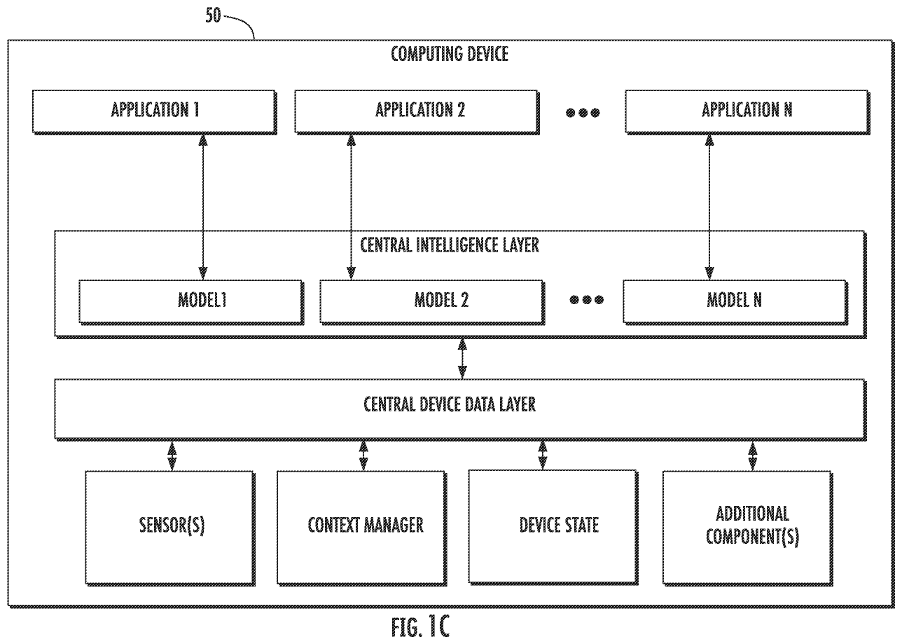

FIG. 1A depicts a block diagram of an example computing system 100 for receiving data describing an electronic item according to example embodiments of the present disclosure. The system 100 can include a user computing device 102, a platform server computing system 130, and/or a financial institution server computing system 140 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations. Electronic items and/or data describing electronic items can be stored in one more local memory locations of the user computing device 102. For example, the local memory location can correspond with the memory 114.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication. The user computing device 102 can also include one or more sensors 124, such as microphones, cameras, temperature sensors, accelerometers, and the like.

In some implementations, the user computing device 102 can include one or more transaction analysis model(s) 126 and/or the platform server computing system 130 can include one or more transaction analysis model(s) 140. The transaction analysis model(s) 126, 140 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks.

The transaction analysis model(s) 126, 140 can be configured to receive transaction data describing the requested financial transaction and/or user data describing the user. In response to receipt of one or more of the transaction data or the user data, the transaction analysis model(s) 126, 140 can output a confidence score with respect to the financial transaction. Data describing the requested financial transaction (e.g., including the confidence score) can be transmitted to the financial institution server computing system(s) 140 (e.g., from the platform server computing system(s) 130 and/or user computing device 102).

The platform server computing system 130 can include one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the platform server computing system 130 to perform operations.

In some implementations, the platform server computing system 130 includes or is otherwise implemented by one or more server computing devices. In instances in which the platform server computing system 130 includes plural server computing devices, such server computing devices can operate according to sequential computing architectures, parallel computing architectures, or some combination thereof.

The financial server computing system 140 can include one or more processors 142 and a memory 144. The one or more processors 142 can be any suitable processing device (e.g., a processor core, a microprocessor, an ASIC, a FPGA, a controller, a microcontroller, etc.) and can be one processor or a plurality of processors that are operatively connected. The memory 144 can include one or more non-transitory computer-readable storage mediums, such as RAM, ROM, EEPROM, EPROM, flash memory devices, magnetic disks, etc., and combinations thereof. The memory 144 can store data 146 and instructions 148 which are executed by the processor 142 to cause the financial server computing system 140 to perform operations.

In some implementations, the financial server computing system 140 includes or is otherwise implemented by one or more server computing devices. In instances in which the financial server computing system 140 includes plural server computing devices, such server computing devices can operate according to sequential computing architectures, parallel computing architectures, or some combination thereof.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned transaction analysis model.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Embodiments

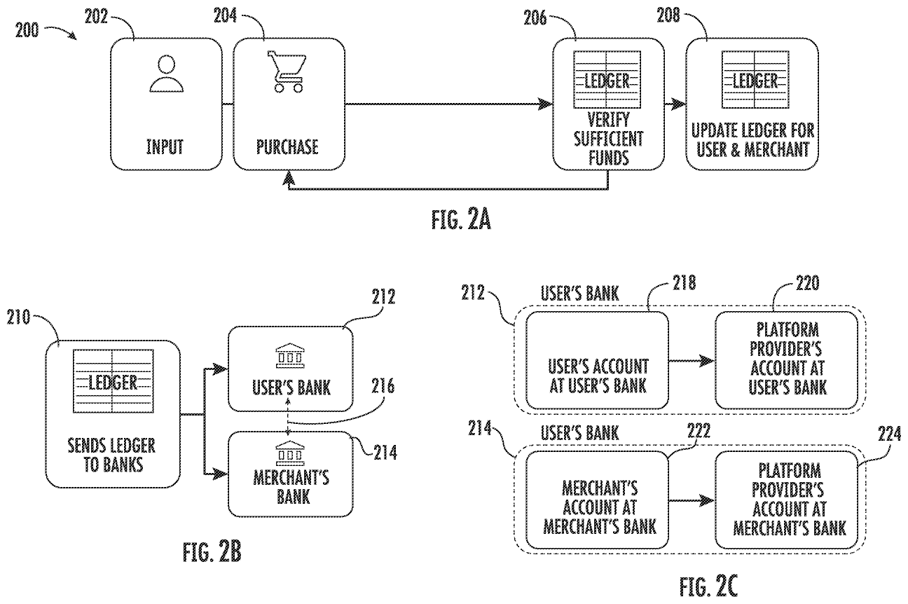

FIG. 2A depicts a simplified flow chart of a method for performing a merchant transaction according to aspects of the present disclosure. As indicated above, the present disclosure is generally directed to systems and methods for performing transactions and/or facilitating transactions with an electronic ledger. More specifically, in some implementations, at 202, a user computing device can to receive an input that requests conducting a financial transaction, at 204 (e.g., with respect to a financial account of a user represented by data stored at a financial institution server system 140). In this example, the input requests that funds be sent to a merchant to pay for a good or service.

The financial platform and/or layer can verify, at 206, that the bank account has sufficient funds to complete the transaction. For example, before adjusting the electronic ledger, a fund balance described by the financial account can be compared to a fund amount described by the financial transaction. For instance, the computing system can verify that the fund amount of the financial transaction is greater than or equal to the fund amount described by the financial transaction.

The electronic ledger can be adjusted, at 208, to conduct or facilitate the financial transaction. The electronic ledger can be maintained at the platform server system 130 that is distinct from the financial institution server system 140. For example, the platform server system 140 can be controlled, operated, and/or maintained by a provider of the financial transaction platform and/or layer. The financial institution can lack control over the electronic ledger and/or the platform server system 130. The financial institution can maintain separate ledgers and/or accounts, for example, by storing data at the financial institution server system 140.

In some implementations, the financial platform provider can authorize the transaction(s) on behalf of the financial institution. For, example, the financial institution server can automatically update the account balance of the financial account in response to receiving the electronic ledger. In other words, the data describing the electronic ledger can be transmitted from the platform server system to the financial institution, at 208, without prior transaction authorization by the financial institution.

In other implementations, however, the financial institution(s) can review and authorize some or all transactions. In such implementations, the financial institution server system can provide an authorization decision in response to receiving an authorization request from the financial platform server system. For example, this request can be sent before updating the electronic ledger(s), at 208. As another example, the financial platform server can provide an authorization decision in response to receiving the electronic ledger. Thus, the financial platform can facilitate the transaction with respect to the platform account layer. FIG. 2B illustrates a flowchart of a settlement procedure according to aspects of the present disclosure. Data that describes the electronic ledger can be transmitted, at 210, from the platform server system 130 to one or more respective financial institution server systems of the user's bank 212 and/or merchant's bank 214 (e.g., one or more financial institution server system(s) 140). For example, a ledger entry that describes the financial transaction and/or a platform account can be transmitted to a financial institution server system of the user's bank 212 and/or a financial institution server system of the merchant's bank 214. The user's bank 212 can transfer funds, at 216, to the merchant's bank 214 to complete the transaction. In some embodiments, the platform provider can effectively authorize transactions on behalf of the financial institutions or banks 212, 214. In such embodiments, the banks 212, 214 can automatically transfer funds, at 216, in response to receipt of the data that describes the electronic ledger, at 210.

Alternatively, instead of the user's bank 212 and merchant's bank 214 directly transferring funds. The platform provider can have an account at one or both of the banks 212, 214. The funds can be transferred via the account(s) of the platform provider. For example, referring to FIG. 2C, funds can be transferred within the user's bank 212 from the user's account 218 at the user's bank 212 to the platform providers' account 220 at the user's bank 212. Funds can also be transferred within the merchant's bank 214 from the platform provider's account 224 at the merchant's bank 214 to the merchant's account 222 at the merchant's bank 214. Thus, in some implementations, one or more accounts 220, 222 of the platform provider can be used to facilitate an effective transfer of funds from the user's account 218 at the user's bank 212 to the merchant's account 222 at the merchant's bank 214.

Aspects of the present disclosure are directed to facilitating fraud detection and/or providing information to help investigate fraud. In one example, the computing system can receive a chargeback request that identifies a suspect transaction. For instance, a user can report a fraudulent transaction to the platform provider and/or bank. Additionally or alternatively, the platform provider and/or bank can flag one or more transactions as suspect, for example based on a time, a location, a merchant, another user involved, or the like of the transaction (e.g., as compared with previous spending habits of the user and/or merchant). In response to receiving the chargeback request the computing system can transmit, from the platform server system to the financial institution server system, data that describes the electronic ledger with respect to the suspect transaction. Transmission of this data can be regulated, encrypted, or otherwise protected to protect private information associated with users and/or merchants. Example data that describes the electronic ledger with respect to the suspect transaction can include a day and/or time of the suspect transaction, a merchant involved with the suspect transaction, a location of the merchant, another user involved with the suspect transaction, a location of the other user, or an amount of the suspect transaction. This information can all be readily available as this information can all be stored by the platform provider (e.g., stored in and/or with the electronic ledger).

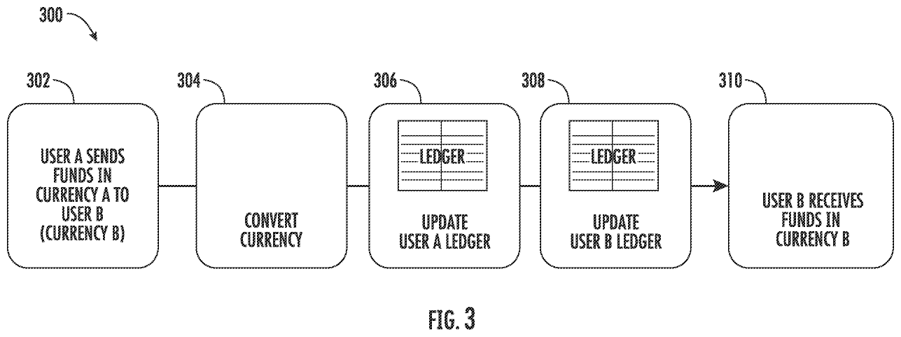

FIG. 3 depicts a simplified flow chart of a method 300 for performing a peer-to-peer transaction according to aspects of the present disclosure. More specifically, in some implementations a user computing device, at 302, can receive an input that requests conducting a financial transaction that includes sending funds from the user to another user. In this example, the user's have bank accounts including funds in different currencies. At 302, one user (“User A”) can send funds in a first currency (“Currency A”) (e.g., U.S. Dollars) to another user (“User B”). User B can have a bank account including funds in a second currency (“Currency B”) (e.g., British Pounds) that is distinct from the first currency. Additionally, in this example, each user can have a platform account that is linked with a respective bank account.

The computing system, at 304, can calculate a currency conversion between Currency A (e.g., U.S. Dollars) and Currency B (e.g., British Pounds). The electronic ledger(s) can be adjusted, at 306 and 308, to conduct or facilitate the financial transaction. In some implementations, multiple electronic ledgers can be used to facilitate the financial transaction. For example, an electronic ledger for user A can be adjusted, at 306, to reflect a change in the account balance for User A (e.g., in Currency A). At 308, an electronic ledger for User B can be updated to reflect a change in the account balance (e.g., in Currency B) for the recipient. As indicated above, the electronic ledger(s) can be maintained at one or more platform server system(s) 130 that are distinct from the financial institution server system(s) 140. For example, the platform server system(s) 140 can be controlled, operated, and/or maintained by a provider of the financial transaction platform and/or layer. At 310, the recipient (“User B”) can receive the funds in his or her currency, for example in the recipient's platform account and/or bank account.

For example, settlement can be performed as described above with reference to FIG. 2B and 2C. Data that describes the electronic ledger can be transmitted from the platform server system to one or more respective financial institution server systems, for example, via one or more international regulatory bodies. Funds can be transferred directly between the respective banks and financial institution server systems, for example as described above with reference to FIG. 2B. For instance, the funds can be automatically transferred in response to receipt of the data that describes the electronic ledger. Alternatively, the platform provider can have respective accounts at User A′s bank and at User B′s bank. Funds can be effectively transferred between User A′s bank account at User A′s bank and User B′s bank account at User B′s Bank be transferring funds between the platform providers respective accounts at each band the user's respective accounts, for example as described above with reference to FIG. 2C.

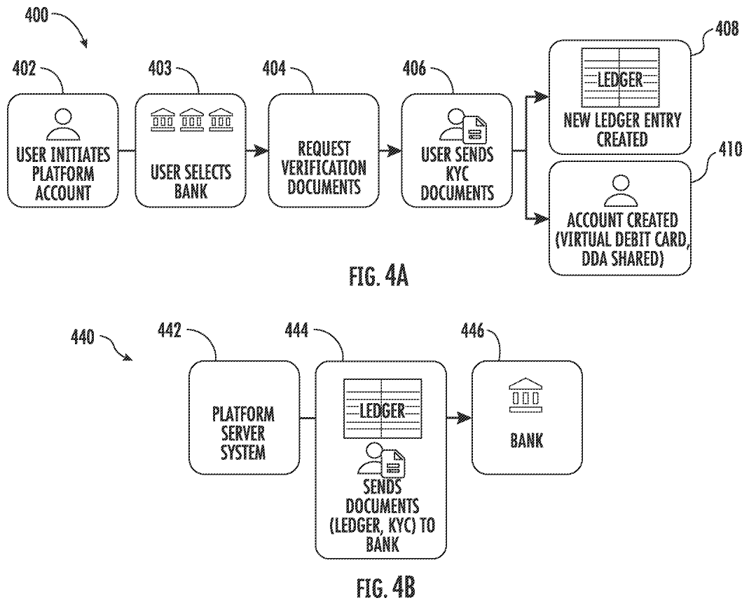

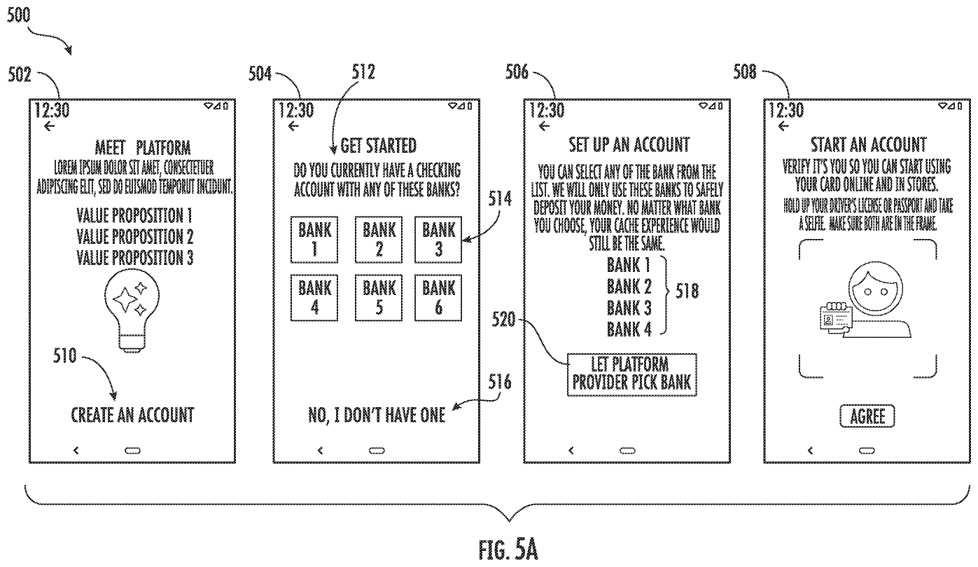

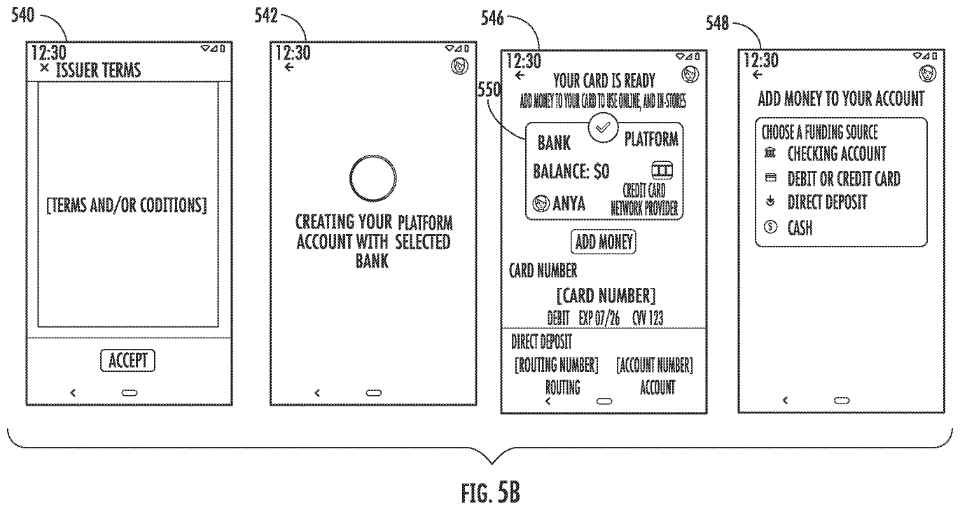

FIG. 4A illustrates is a simplified flowchart of a method 400 for setting up a new platform account and setting up a bank account for a user. The method 400 can be partially performed via a platform application that can provide the user with an interface for setting up a new platform account and/or performing transactions with the platform account, for example as described below with reference to FIG. 5. Referring to FIG. 4A, at 402, a user can request that a new platform account be setup and/or created. For example, the user can provide an input via a platform application that request that the new platform account be setup. At 403, The user can select a bank for setting up a new bank account.

The computing system, at 404, can request information or documents from the user to verify the user's identity (e.g., KYC documentation). The user, at 406, can provide information to verify the user's identity. For example, the computing system can receive, at the user computing device, user information, such as a photograph of the user's face, the user's name, user's date of birth, user's address, and the like.

The computing system, at 408, can create a new electronic ledger for the user and/or create a new ledger entry in an existing electronic ledger, for example, at the platform server computing system(s) 130. A new platform account can be created, at 410, for the user. For example, the data describing the new platform account can be stored at the platform server computing system(s) 130.

FIG. 4B illustrates a simplified flowchart of a method 440 for setting up the new bank account and/or platform account for the user. The method 440 can be completed in separately or in combination with the method 400 described above with reference to FIG. 400. For example, the platform server 442 (e.g., corresponding with the platform server computing system(s) 130 of FIG. 1) can transmit, at 444, data describing the electronic ledger and/or ledger entry (e.g., corresponding with the ledger and/or entry that was created at 408 in FIG. 4A) and/or data describing the user information (e.g., KYC documentation) to the bank 446 (e.g., financial institution server computing system(s) 140). The bank 446 can verify the user's identity based on the user information. The bank 446 can create a new bank account for the user.

FIG. 5A illustrates an example series of views 502, 504, 506, 508 of a user interface depicting a method 500 for creating a new platform account and bank account for a user according to aspects of the present disclosure. In view 502, the user interface can include a welcome screen and a button or link 510 providing the user with an option to create an account. In response to the user providing an input requesting that an account be created (e.g., a touch input directed to the button or link 510), the user interface can display the second view 504. The input directed to the button or link 510 requesting that an account be created can correspond with step 402 of FIG. 4A.

The second view 504 can display text 512 asking whether the user currently has a bank account with a variety of participating banks 514. The second view 504 can also include a button or link 516 allowing the user to indicate that he or she does not have a bank account with one of the participating banks 514.

The third view 506 can provide the user with a list of one or more banks 518. The third view 506 can be displayed in response to a user input indicating that the user does not have a bank account with one of the participating banks 514 (e.g., a user touch action directed to the button or link 516 of the second view 504). The user can select one of the banks 518 in the third view 506 to request that a new bank account be setup with the selected bank, for example corresponding with step 403 of FIG. 4A. Alternatively, the user can elect to have the platform provider select a bank for the user, for example by directing a user input to a button or link 520 providing this option.

The fourth view 508 can provide the user with an ability to input user information, such as KYC information or documentation. As one example, the fourth view 508 can provide the user with an option to capture a picture of the user's face (e.g., a “selfie”) and/or a picture of an identification card (e.g., driver's license, passport, etc.) of the user. The computing system can transmit the picture(s) to the bank (e.g., corresponding with step 444 of FIG. 4B). The bank can verify the user's identity before setting up a new bank account for the user.

FIG. 5B illustrates additional views 540, 542, 546, 548 corresponding with additional steps for creating the platform account and bank account. For example, a fifth view 540 can be displayed after the fourth view 508 of FIG. 5A. The fifth view 540 can include terms and conditions for the user to review and accept.

A sixth view 542 can inform the user that a platform account and/or bank account is being created for the user in conjunction with the bank that was selected by the user. The computing system can create a platform account for the user. The computing system can create an electronic ledger and/or ledger entry for the user, for example as described above, with reference to step 408 of FIG. 4A).

A seventh view 546 can include a view of digital card 550 corresponding with the newly created platform account and/or bank account. For example, the digital card 550 can correspond with tokenized version of a debit card that is linked to bank account.

An eighth view 548 can provide the user with an option to load funds to the newly created platform account from various sources, such as the user's checking account, debit or credit card, direct deposit (e.g., from an employer), and/or a cash deposit (e.g., at a bank or ATM). However, it should be understood that, in some embodiments, the platform account can act as a layer through which transaction are conducted with the user's bank account. In such embodiments, the platform account balance can correspond with (e.g., be equal to) the bank account balance. In other words, as indicated above, the platform account can (1) act as an interface/layer through which the user can conduct transactions with the linked bank account and/or (2) act as a stand-alone account including separate funds than the user's bank account.

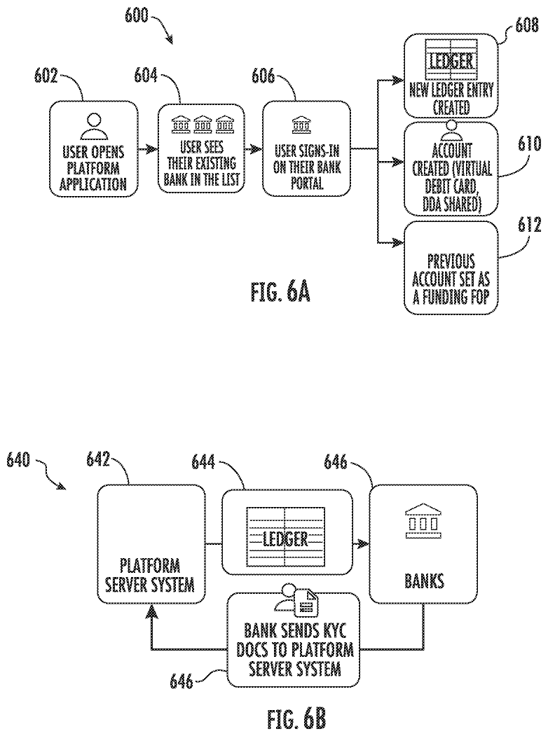

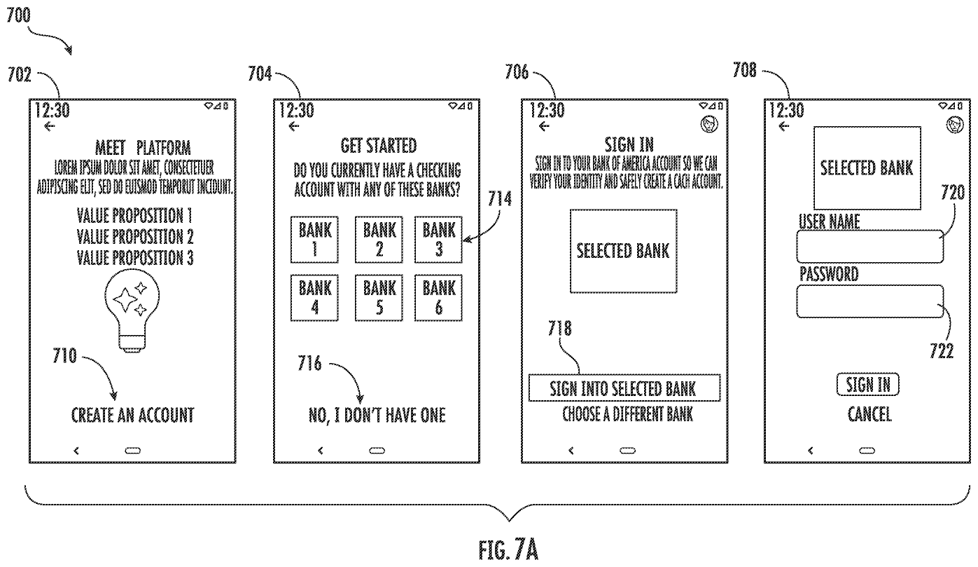

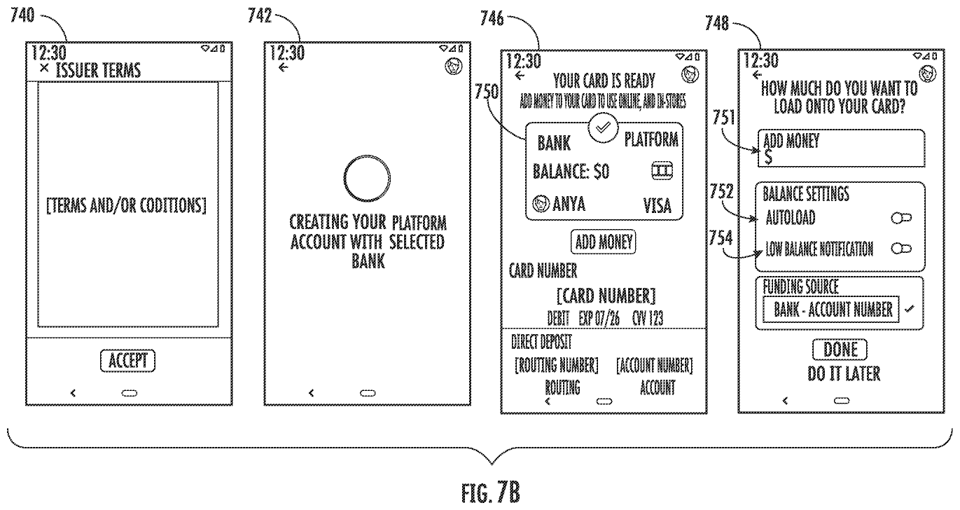

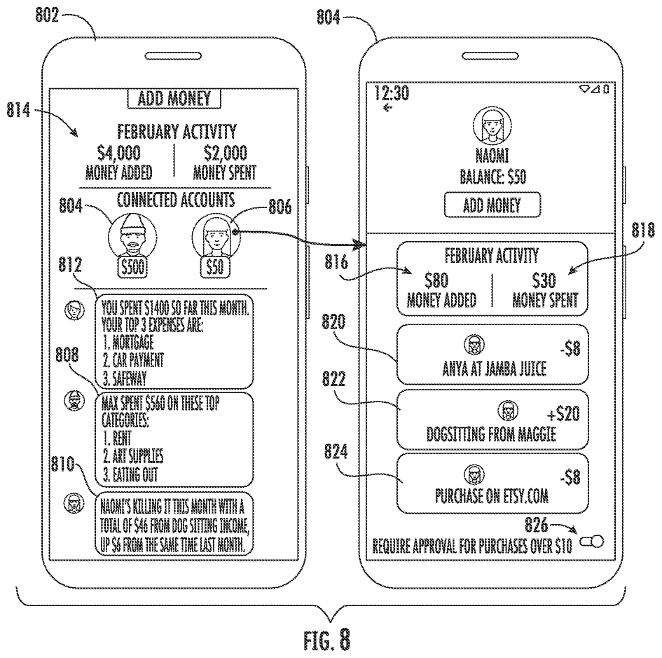

FIG. 6A illustrates is a simplified flowchart of a method 600 for setting up a new platform account in associated with an existing bank account of the user. The method 600 can be partially performed via a platform application that can provide the user with an interface for setting up a new platform account and/or performing transactions with the platform account, for example as described below with reference to FIG. 7A. Referring to FIG. 6A, at 602, a user can request that a new platform account be setup. For example, the user can provide an input via a platform application that request that the new platform account be setup, for example as described below with reference to FIG. 7A.

At 604, the user can select a bank at which the user has an existing bank account. The user can, at 606, sign into his or her bank portal, for example via the platform application, to link the new platform account with the existing bank account.

The computing system, at 608, can create a new electronic ledger for the user and/or create a new ledger entry in an existing electronic ledger, for example, at the platform server computing system(s) 130. At 610, the computing system can create a platform account for the user. At 612, the computing system can link the platform account to the existing bank account such that the platform account acts as a transaction layer through which the user can control transactions for the existing bank account.

FIG. 6B illustrates a simplified flowchart of a method 640 for setting up the new platform account and/or linking the platform account to the existing bank account of the user. The method 640 can be completed in concert with the method 600 described above with reference to FIG. 600. For example, the platform server 642 (e.g., corresponding with the platform server computing system(s) 130 of FIG. 1) can transmit, at 644, data describing the electronic ledger and/or ledger entry (e.g., corresponding with the ledger and/or entry that was created at 608 in FIG. 6A). The bank 646 can transmit data describing user information (e.g., KYC documentation) to the platform server system 642 (e.g., corresponding with the platform server computing system 130).

FIG. 7A illustrates an example series of views 702, 704, 706, 708 of a user interface depicting a method 700 for creating a new platform account and bank account for a user according to aspects of the present disclosure. In view 702, the user interface can include a welcome screen and a button or link 710 providing the user an option to create an account. In response to the user providing an input requesting to create an account (for example a touch input directed to the button or link 710), the user interface can display the second view 704. This input requesting to create an account can correspond with step 602 of FIG. 6A.

The second view 704 can display text 712 asking whether the user currently has a bank account with a variety of participating banks 714. The second view 704 can also include a button or link 716 allowing the user to indicate that he or she does not have a bank account with one of the participating banks 714.

The third view 706 can provide the user with a prompt 718 to sign into an account at a selected bank. For example, the user can select one of the participating banks 714 in the second view 704. In response, the computing device can display the third view 706.

The fourth view 708 can provide the user with input windows 720, 722, in which the user can input credentials to sign into the user's account at the selected bank, for example corresponding with step 606 of FIG. 6A. The user can sign into his or her bank account at the selected bank and the computing system can create a platform account for the user and link the platform account with the user's existing bank account, for example as described with reference to steps 608-612 of FIG. 6A.

FIG. 7B illustrates additional views 740, 742, 746, 748 corresponding with additional steps for creating the platform account and linking the platform account with the bank account. The additional views 740, 742, 746, 748 can generally correspond with the additional views 540, 542, 548 of FIG. 5B. The eighth view 748 can provide the user with an option to load funds to the newly created platform account. However, it should be understood that in some embodiments, the platform account can act as a layer through which transaction are conducted with the user's bank account. In such embodiments, the platform account balance can correspond with (e.g., be equal to) the bank account balance. In other words, as indicated above, the platform account can (1) act as an interface/layer through which the user can conduct transactions with the linked bank account and/or (2) act as a stand-alone account including separate funds than the user's bank account.

Referring to the eighth view 748, additional options can be provided for loading funds into the user's platform account. These options are generally applicable to embodiments in which the platform account acts as a stand-alone account having separate funds than the user's bank account. The user can enter an amount in an entry window 751 to transfer into the user's platform account (e.g., from the user's bank account). For example, an “autoload” option 752 can be provided in which the user can setup repeating automatic transfers from the user's bank account to the user's platform account. A “low balance notification” option 754 can also be provided in which the computing system can notify the user when the balance of the user's platform account is below a threshold amount (e.g., as set by the user or automatically set by the platform provider).

FIG. 8 illustrates a first view 802 and second view 804 of a user interface configured to allow a user to set privileges or constraints with respect to other accounts, for example accounts of the user's children. In the first view 802, several “connected accounts” 804, 806 can be displayed for selection. In this example, the “connected accounts” 804, 806 can correspond with children accounts. Information panels 808, 810 can be displayed including activity of the connected accounts 804, 806 can be displayed for a primary user, such a parent or guardian. For example, the information panels 808, 810 can include spending summaries by category, time, or the like for respective connected accounts 804, 806. A primary user information panel 812 can include information about the primary user's account, such as spending summary information by category, time, and the like. Aggregate account information 814 can be displayed, such as total funds added in the current month, total spent from all accounts in combination in the current month, and/or other suitable summary information.

In response to a user input directed to one of the connected accounts 806, additional information can be displayed in the second view 804 about the selected connected account 806. For example, money added 816, money spent 818, and/or information about individual transactions 820, 822, 824 can be displayed.

The primary user (e.g., parent and/or guardian) can set privileges and/or constraints for the connected account. For example, the second view 804 can provide the primary user with the option to require the approval from the primary user for certain types of transactions. For instance, a slider bar 826 can be provided that prevents the user of the connected account from conducting transactions over a dollar amount (e.g., $10) without the primary user's approval. As additional examples, the primary user can enter and set transaction limits, location alerts, spending category alerts, and the like.

In some embodiments, financial institutions can set one or more controls or privileges using the platform. For example, the financial institution can set spending limits, withdrawal limits, or other limits for transactions for the financial account. The computing system (e.g., transaction service platform and/or platform application) can compare the financial transaction requested by the input with the controls set by the financial institution. The computing system can determine whether the financial transaction is permitted based on the comparison of the financial transaction with the control(s) set by a financial institution.

In some implementations, the user (e.g., primary user) can set controls or privileges for his or her own platform account(s). For example, the user can set a spending limit per day, week, or month for total spending and/or for particular spending categories. If the user attempts to spend more than the limit, than the platform application can remind the user of the limit and ask the user he or she wishes to exceed the limit. Additional examples can include location-based alerts based on user preferences and/or controls. For instance, if a user has set a monthly budget for grocery spending, the platform application can present a notification when the user's location is detected at a grocery store, if the user has so consented. The notification can indicate a remaining balance of the monthly budget set for grocery spending.

In some implementations, financial institutions can set one or more controls or privileges for the platform account(s). For example, the financial institution can set spending limits, withdrawal limits, or other limits for transactions for the financial account. The computing system (e.g., transaction service platform and/or platform application) can compare the financial transaction requested by the input with the controls set by the financial institution. The computing system can determine whether the financial transaction is permitted based on the comparison of the financial transaction with the control(s) set by a financial institution.

In some implementations, the computing system (e.g., transaction service platform and/or platform application) can facilitate transactions that include interactions with physical currency. Such transactions can be initiated from a user computing device (e.g., smartphone, tablet, laptop, etc.) or from an automated teller machine (ATM).

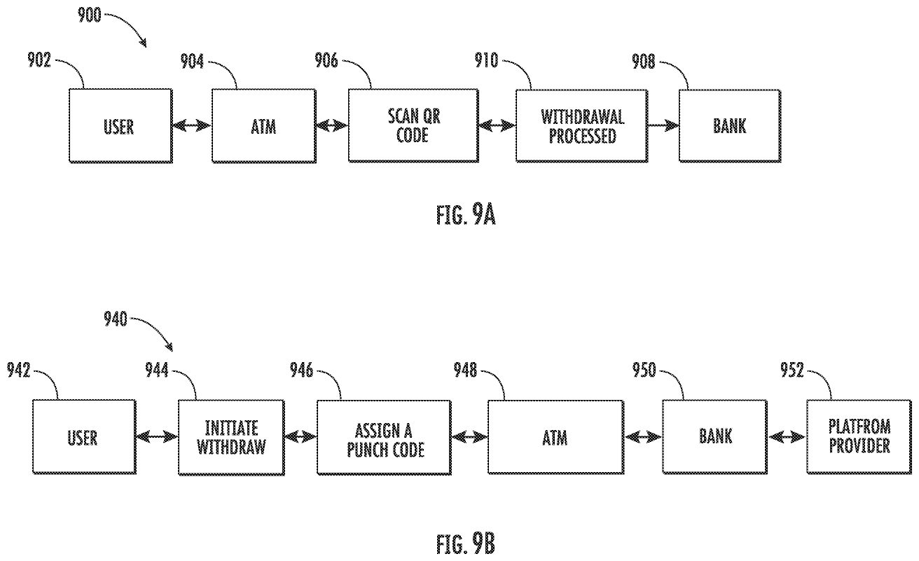

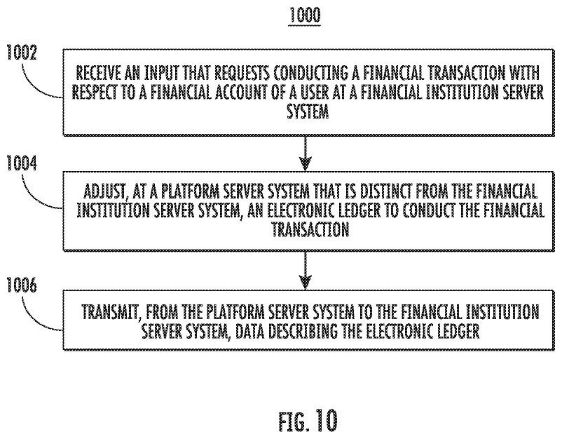

FIG. 9A depicts a simplified flow chart diagram of an example method 900 for depositing or withdrawing physical currency from the user's platform account that can be initiated at an ATM or bank. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a user initiating a deposit or withdrawal at an ATM 904. The ATM 904 can present a unique image, such as a QR code, bar code or the like, for the user to scan or photograph, at 906. More specifically, the platform application can be configured to access a camera of the user's computing device 102 to photograph the unique image. The platform application can be configured to verify the identity of the user with the unique code. For example, the platform application can decode the QR code and/or transmit the photograph of the unique code to the platform server computing system(s) 130 and/or financial institution server computing system(s) 140. The platform application can transmit a message (e.g., including authenticating credentials and/or the photograph of the unique image) to the ATM 904 and/or a bank 908 (e.g., financial institution server computing system(s) 140). The withdrawal can be processed, at 910, by the ATM 904 and/or bank 908. The ATM 904 can disburse cash for withdrawal. The ATM 904 can communicate data describing the withdrawal to the bank 908. The bank 908 can update the account balance of the user's bank account. The platform provider can update the balance of the user's platform account.

FIG. 9B depicts a simplified flow chart diagram of an example method 940 for depositing or withdrawing physical currency from the user's platform account that can be initiated with the user's computing device 102 and/or platform application. Although FIG. 9B depicts steps performed in a particular order for purposes of illustration and discussion, the methods of the present disclosure are not limited to the particularly illustrated order or arrangement. The various steps of the method 940 can be omitted, rearranged, combined, and/or adapted in various ways without deviating from the scope of the present disclosure.

A user 942 can initiate a withdrawal, at 944, using the user's computing device 102. The platform application can provide the user with an option to withdraw cash. The user can provide an input to the platform application that requests withdrawal from a bank or ATM. The user can input an amount that the user wishes to withdraw. The platform application can suggest a nearby location of an ATM or bank to complete the withdrawal, for example, based on a location of the user (e.g., as detected by the user's computing device 102). The platform application can assign a unique code (e.g., “punch code”) to the withdrawal, at 946. Once the user arrives at an ATM 948, the user can enter the unique code to complete the transaction. The ATM 948 can verify the identity of the user in response to receiving the unique code. Alternatively, in some embodiments, the ATM 948 can detect a unique image (e.g., QR code) displayed by user computing device to verify the user's identity.

One the user's identity is verified, the ATM 948 can disburse the requested cash to the user. The ATM 948 can communicate data describing the withdrawal to the bank 950. The bank 950 can update the account balance of the user's bank account. The bank 950 can transmit confirmation of the transaction to the platform provider 952 (e.g., the financial institution server system(s) 140). The platform provider 952 can update the balance of the user's platform account.

Other transactions involving physical currency can be initiated with a merchant. For instance, the user can pay a merchant with cash for a good or service using physical currency. The merchant and/or computing system can provide the user with an option to receive change for the transaction via the transaction service platform and/or platform application. The computing system (e.g., transaction service platform and/or platform application) can facilitate a transaction from the merchant's platform account to the user's platform account that provides the user with change for the original transaction with the merchant.

### Example Methods

FIG. 10 depicts a flow chart diagram of an example method for performing transactions with an electronic ledger. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a computing system can receive, at a user computing device, an input that requests conducting a financial transaction with respect to a financial account that is provided by a financial institution. For example, the user can request funds by sent to another user in a peer-to-peer transaction. As another example, a user can request that funds by sent to a merchant to pay for a good or service.

At 1004, the computing system can adjust an electronic ledger that is controlled by an entity that is different and distinct from the financial institution to conduct the financial transaction, for example as described above with reference to FIGS. 2A through 4B. For instance, the electronic ledger can be adjusted at the platform server computing system(s) 130 that is distinct from the financial institution server system(s) 140. For example, the data describing the electronic ledger can be transmitted to a financial institution server system that is distinct from the platform server system. The data describing the electronic ledger can be transmitted from the platform server system to the financial institution without prior transaction authorization by the financial institution. Thus, in some embodiments, the platform provider can automatically authorize the transaction on behalf of the financial institution.

At 1006, the computing system can transmit, from the platform server system to the financial institution, data describing the electronic ledger, for example as described above with reference to FIGS. 2A through 4B. For instance, data describing the electronic ledger can be transmitted from the platform server computing system(s) 130 to the financial institution server system(s) 140. In some embodiments, before transmitting the data describing the electronic ledger from the platform server system to the financial institution, the computing system can transmit, from the platform server system to the financial institution, an authorization request for the financial transaction. The financial institution can review the request and determine whether to authorize the transaction. If the financial institution determines to authorize the transaction, the computing system can receive, at the platform server system, the authorization request for the financial transaction before transmitting the data describing the electronic ledger.

In some implementations, the platform provider can perform an analysis of the requested transaction and provide the financial institution with this analysis to facilitate the financial institution's determination of whether to authorize the requested transaction. For example, the platform provider can facilitate generation of a confidence score for the requested transaction request. The confidence score can describe relative risk of the requested transaction request, for example risk that the requested transaction request is fraudulent. The confidence score can be transmitted to the financial institution server computing system to assist the financial institution server computing system when determining whether to authorize the transaction.

In some implementations, one or more machine-learned models can be used to generate the confidence score, for example as described with reference to the transaction analysis model(s) 126, 140 described above with reference to FIGS. 1A through 1C. The data describing the requested financial transaction that is transmitted to the financial institution server computing system(s) can include data describing the confidence score. Thus, one or more machine-learned models can be used to generate analysis data for the requested transaction to help facilitate the financial institution's determination of whether to authorize the requested transaction.

However, in other embodiments, the platform provider can authorize the transaction and the finical institution can automatically transfer funds in response to receiving the data that describes the electronic ledger.

In some embodiments, the method 1000 can include before transmitting the data describing the electronic ledger from the platform server system to the financial institution, at 1006, transmitting, from the platform server system to the financial institution, an authorization request for the financial transaction.

In some embodiments, the data describing the electronic ledger can include a confidence score with respect to the financial transaction requested by the user input.

In some embodiments, the method 1000 can include inputting one or more of transaction data describing the financial transaction and user data describing the user into a machine-learned transaction analysis model configured to receive one or more of the transaction data or the user data, and in response to receipt of one or more of the transaction data or the user data, output the confidence score with respect to the financial transaction.

In some embodiments, the method 1000 can include before transmitting the data describing the electronic ledger from the platform server system to the financial institution, at 1006, receiving, at the platform server system, the authorization request for the financial transaction.

In some embodiments, the method 1000 can include before adjusting the electronic ledger, at 1004, comparing a fund balance described by the financial account to a fund amount described by the financial transaction. In some embodiments comparing the fund balance described by the financial account to the fund amount described by the financial transaction can include verifying that the fund balance described by the financial account is greater than or equal to the fund amount described by the financial transaction.

In some embodiments, the financial transaction describes one or more of a peer-to-peer transaction and a merchant transaction. Adjusting the electronic ledger to conduct the financial transaction can include at least one of adjusting or creating a ledger entry that describes the one or more of the peer-to-peer transaction and the merchant transaction.

The financial transaction can describe a physical currency interaction including at least one of depositing or withdrawing physical currency with respect to the financial account.

In some embodiments, the method 1000 can include receiving a chargeback request that identifies a suspect transaction, and in response to receiving the chargeback request, transmitting, from the platform server system to the financial institution server system, data that describes the electronic ledger with respect to the suspect transaction. The data that describes the electronic ledger with respect to the suspect transaction describes at least one of a transaction day of the suspect transaction, a transaction time of the suspect transaction, an identify of a merchant involved with the suspect transaction, a location of the merchant, an identify of another user involved with the suspect transaction, a location of the another user, or an amount of the suspect transaction.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, comprising:
at least one processor;
at least one tangible, non-transitory computer-readable medium that stores instructions that, when executed by the at least one processor, cause the at least one processor to perform operations, the operations comprising:
receiving, at a user computing device, an input that requests conducting a financial transaction with respect to a financial account that is provided by a financial institution;
adjusting, at a platform server system that is controlled by an entity that is different and distinct from the financial institution, an electronic ledger to conduct the financial transaction; and
transmitting, from the platform server system to the financial institution, data describing the electronic ledger.

2. The computing system of claim 1, wherein transmitting the data describing the electronic ledger from the platform server system to the financial institution comprises transmitting the data describing the electronic ledger to a financial institution server system that is distinct from the platform server system.

3. The computing system of claim 1, wherein the operations further comprise, before transmitting the data describing the electronic ledger from the platform server system to the financial institution:
transmitting, from the platform server system to the financial institution, an authorization request for the financial transaction.

4. The computing system of claim 1, wherein the operations further comprise, before transmitting the data describing the electronic ledger from the platform server system to the financial institution:
receiving, at the platform server system, the authorization request for the financial transaction.

5. The computing system of claim 1, wherein the data describing the electronic ledger comprises a confidence score with respect to the financial transaction requested by the user input.

6. The computing system of claim 5, further comprising a machine-learned transaction analysis model configured to receive one or more of transaction data describing the financial transaction and user data describing the user, and in response to receipt of one or more of the transaction data or the user data, output the confidence score with respect to the financial transaction.

7. The computing system of claim 1, wherein the operations further comprise, before adjusting the electronic ledger:
comparing a fund balance described by the financial account to a fund amount described by the financial transaction.

8. The computing system of claim 7, wherein comparing the fund balance described by the financial account to the fund amount described by the financial transaction comprises verifying that the fund balance described by the financial account is greater than or equal to the fund amount described by the financial transaction.

9. The computing system of claim 1, further comprising a platform application, and wherein the operations further comprise providing, for display by the user computing device in a display window of the platform application, data describing the financial transaction.

10. The computing system of claim 1, wherein the financial transaction describes a peer-to-peer transaction between the user and another user, and wherein adjusting the electronic ledger to conduct the financial transaction comprises at least one of adjusting or creating a ledger entry that describes the peer-to-peer transaction.

11. The computing system of claim 1, wherein the financial transaction describes a merchant transaction between the user and a merchant, and wherein adjusting the electronic ledger to conduct the financial transaction comprises at least one of adjusting or creating a ledger entry that describes the merchant transaction.

12. The computing system of claim 1, wherein the financial transaction describes a physical currency interaction comprising at least one of depositing or withdrawing physical currency with respect to the financial account.

13. The computing system of claim 1, wherein the operations further comprise:
receiving a chargeback request that identifies a suspect transaction;
in response to receiving the chargeback request, transmit, from the platform server system to the financial institution server system, data that describes the electronic ledger with respect to the suspect transaction.

14. The computing system of claim 13, wherein the data that describes the electronic ledger with respect to the suspect transaction describes at least one of:
a day of the suspect transaction;
a time of the suspect transaction;
an identify of a merchant involved with the suspect transaction;
a location of the merchant;
an identify of another user involved with the suspect transaction;
a location of the another user; or
an amount of the suspect transaction.

15. The computing system of claim 1, wherein the operations further comprise, before adjusting the electronic ledger:
comparing the financial transaction requested by the input with one or more privileges settings for the user set by the user or by another user; and
determining that the financial transaction is permitted based on the comparison of the financial transaction with the one or more privileges settings for the user.

16. The computing system of claim 1, wherein the operations further comprise, before adjusting the electronic ledger:
comparing the financial transaction requested by the input with one or more controls set by a financial institution;
determining that the financial transaction is permitted based on the comparison of the financial transaction with the one or more controls set by a financial institution.

17. The computing system of claim 1, wherein the operations further comprise:
receiving, at the user computing device, user information;
transmitting, to the financial institution server system, data describing the user information; and
verifying, at the financial institution server system, an identity of the user based on the user information.

18. The computing system of claim 1, wherein the operations further comprise:
receiving, at the user computing device, an input that requests creating the financial account at the financial institution server system; and
transmitting, to the financial institution server system, a request for creating the financial account at the financial institution server system.

19. A computer-implemented method comprising:
receiving, at a user computing device, an input that requests conducting a financial transaction with respect to a financial account that is provided by a financial institution;
adjusting, at a platform server system that is controlled by an entity that is different and distinct from the financial institution, an electronic ledger to conduct the financial transaction; and
transmitting, from the platform server system to the financial institution, data describing the electronic ledger.

20. The computer-implemented method of claim 19, wherein transmitting the data describing the electronic ledger from the platform server system to the financial institution comprises transmitting the data describing the electronic ledger to a financial institution server system that is distinct from the platform server system.
